(19) United States
(12) Patent Application Publication
(10) Pub. No.: US 2020/0147909 A1
(43) Pub. Date: May 14, 2020

(54) Record Making System

(71) Applicant: Viryl Technologies Corp., Toronto (CA)

(72) Inventors: Chad W.T. Brown, Toronto (CA); Greg Mulkerns, Toronto (CA); Joshua Ghent, Hamilton (CA); Michael Wybenga, Hamilton (CA); Robert H. Brown, Ancaster (CA); James Hashmi, Toronto (CA)

(73) Assignee: Viryl Technologies Corp., Toronto (CA)

(21) Appl. No.: 16/681,296

(22) Filed: Nov. 12, 2019

Related U.S. Application Data
(60) Provisional application No. 62/757,962, filed on Nov. 9, 2018.

(30) Foreign Application Priority Data
Sep. 9, 2019 (CA) 3054694

(51) Int. Cl. B29D 17/00

(52) U.S. Cl. CPC B29D 17/002; B29L 2017/003

(57) ABSTRACT

The improved record press is of the type wherein a relatively hot fluid is circulated through the platens to render the puck molten for molding and wherein a relatively cold fluid is circulated through the platens to cool the molten material for ejection. The improvement comprises the use of pressurized water as the relatively hot fluid.

### CROSS-REFERENCE TO RELATED APPLICATIONS

This application claims the priority of Canadian Patent Application No. 3054694, filed Sep. 9, 2019 and U.S. Provisional Patent Application No. 62/757,962, filed Nov. 9, 2018.

### FIELD

The invention relates to the production of vinyl records.

### BACKGROUND

In the production of vinyl records, it is ubiquitous to utilize steam to heat the platens, to render the vinyl molten for molding, and cooling water to cool the platens, to harden the record for ejection.

### SUMMARY OF THE INVENTION

An improved record press forms one aspect of the invention. The record press is of the type wherein a relatively hot fluid is circulated through the platens to render the puck molten for molding and wherein a relatively cold fluid is circulated through the platens to cool the molten material for ejection. The improvement comprises the use of pressurized water as the relatively hot fluid.

According to another aspect of the invention, the pressurized water can be produced by a temperature control unit.

According to another aspect of the invention, the temperature control unit can be a REGOPLAS P161XL60SM85HSKRT100.

### DETAILED DESCRIPTION OF AN EXEMPLARY EMBODIMENT

In an exemplary embodiment of the invention, the record making system described in PCT/CA2017/051521 was decoupled from the 99% saturated steam supply and coupled in turn to a REGOPLAS P161XL60SM85HSKRT100 temperature control unit [TCU]. Water temperature was set at 300 F @ 120 psi. Suitable valving and control systems were provided to provide hot water from the TCU in the heating cycle and cooling water from the chiller in the chilling cycle; valving and control systems of this type are a matter of routine to persons of ordinary skill in the art and as such, details are neither required nor provided.

Experimental: use of the hot water system provided cycle time comparable to that of the steam system which it replaced.

Persons of ordinary skill will appreciate that the removal of the boiler is advantageous given that boilers are often large and costly and have specialized maintenance requirements.

Moreover, even in situations wherein steam is available, the present system may be advantageous, since steam quality often varies significantly in industrial settings and this imposes limitations upon cycle time that can be obviated through the water system.

Whereas a specific embodiment is herein described, variations are possible:
water temperature and pressure could be varied
temperature control units other than the REGOPLAS unit could be employed
hot water could be provided through mechanisms other than a temperature control unit of the REGOPLAS type
hot liquids other than water could potentially be used for heating and cooling

Accordingly, the invention should be limited only by the accompanying claims, purposively construed.

1. An improved record press, the record press being of the type wherein a relatively hot fluid is circulated through the platens to render the puck molten for molding and wherein a relatively cold fluid is circulated through the platens to cool the molten material for ejection, the improvement comprises:
the use of pressurized water as the relatively hot fluid.

2. The press of claim 1, wherein the pressurized water is produced by a temperature control unit.

3. The press of claim 2, wherein the temperature control unit can be a REGOPLAS P161XL60SM85HSKRT100.
